(19) United States
(12) Patent Application Publication
(10) Pub. No.: US 2026/0346573 A1
(43) Pub. Date: Nov. 5, 2026

(54) LAMINATED CORE AND MANUFACTURING METHOD OF LAMINATED CORE

(71) Applicant: NIPPON STEEL CORPORATION, Tokyo (JP)

(72) Inventors: Takahito MIZUMURA, Tokyo (JP); Hisashi MOGI, Tokyo (JP); Masaru TAKAHASHI, Tokyo (JP)

(73) Assignee: NIPPON STEEL CORPORATION, Tokyo (JP)

(21) Appl. No.: 19/112,543

(22) PCT Filed: Sep. 28, 2023
(86) PCT No.: PCT/JP2023/035358

§ 371 Date: Mar. 17, 2025

(30) Foreign Application Priority Data
Oct. 3, 2022 (JP) 2022-159532

(51) Int. Cl. B32B 15/01; B32B 3/26; B32B 38/00; H01F 3/02; H01F 41/02

(52) U.S. Cl. CPC B32B 15/011; B32B 3/266; B32B 38/0004; B32B 38/0012; H01F 3/02; H01F 41/0233; B32B 2038/0016; B32B 2307/538

(57) ABSTRACT

At each of at least one pair of block facing end surfaces (for example, a pair of block facing end surfaces (111a and 111i)), 1<Ra(D)/Ra(S)≤12 is satisfied. Here, Ra(D) is surface roughness Ra (μm) of the block facing end surface in a laminating direction. Ra(S) is surface roughness Ra (μm) of a sheet surface of the steel sheet having an end surface that forms part of the block facing end surface in a main magnetic flux direction (or a rolling direction).

### TECHNICAL FIELD

The present invention relates to a laminated core and a manufacturing method of a laminated core. This application is based upon and claims the benefit of priority of the prior Japanese Patent Application No. 2022-159532, filed on Oct. 3, 2022, the entire contents of which are incorporated herein by reference.

### BACKGROUND ART

In a laminated core made by laminating a plurality of steel sheets, each of the laminated steel sheets vibrates when excited. The vibration of each of the steel sheets may cause noise to be generated from the laminated core. Therefore, there is a need for the technique to inhibit such vibration of steel sheets. As this type of technique, there have been techniques described in Patent Literatures 1 to 4.

Patent Literature 1 has disclosed that a damping steel sheet is partially interposed between a plurality of laminated electrical steel sheets.

Patent Literature 2 has disclosed that after processed grooves are formed in the sheet surface of each electrical steel sheet, a plurality of electrical steel sheets are laminated so as to prevent the sheet surfaces with no processed grooves formed therein from overlapping each other. Further, Patent Literature 2 has disclosed that an adhesive resin is applied to end surfaces of a plurality of the laminated electrical steel sheets.

Patent Literature 3 has disclosed providing, on a plane forming the outer circumference of a core, a stress member that is compressively deformed along the longitudinal direction of the plane.

Patent Literature 4 has disclosed laminating a plurality of electrical steel sheets, each of the electrical steel sheets including an insulating coating that contains 4.9 to 7.1% of Si and has Rmax as surface roughness of 3.5 μm or more. Further, Patent Literature 4 has disclosed inserting an impregnant that also functions as an adhesive between a plurality of the laminated electrical steel sheets.

### CITATION LIST

### Patent Literature

Patent Literature 1: Japanese Laid-open Patent Publication No. 2006-14555
Patent Literature 2: Japanese Laid-open Patent Publication No. 2003-77747
Patent Literature 3: Japanese Laid-open Patent Publication No. 2000-114064
Patent Literature 4: Japanese Laid-open Patent Publication No. 04-361508

### SUMMARY OF INVENTION

### Technical Problem

However, the techniques described in Patent Literatures 1 to 4 require a material different from the steel sheet for inhibiting vibration of the laminated core.

The present invention has been made in consideration of the above problems, and an object thereof is to provide a laminated core that is capable of inhibiting vibration without using a material different from a steel sheet.

### Solution to Problem

The laminated core of the present invention includes: a plurality of blocks, each of the blocks including a plurality of laminated steel sheets, in which the plural blocks include block facing end surfaces, the block facing end surface is, of end surfaces of the block, an end surface that is located at a position facing the another block each other, at each of at least one pair of the block facing end surfaces, (A) Expression below is satisfied, and the pair of block facing end surfaces is the two block facing end surfaces that are arranged at positions facing each other.

1<Ra(D)/Ra(S)≤12 (A)

Here, Ra(D) is surface roughness Ra (μm) of the block facing end surface in a laminating direction of the steel sheet, and Ra(S) is surface roughness Ra (μm) of a sheet surface of the steel sheet having an end surface that forms part of the block facing end surface in a direction of a main magnetic flux flowing through the steel sheet or in a rolling direction of the steel sheet.

The manufacturing method of a laminated core of the present invention is a manufacturing method of a laminated core, the laminated core including a plurality of blocks, each of the blocks including a plurality of laminated steel sheets, the method includes: a cutting step that cuts a steel sheet; a first roughness measuring step that measures surface roughness Ra(S) (μm) of a sheet surface of a steel sheet cut at the cutting step; a second roughness measuring step that measures surface roughness Ra(D) φm) of a block facing end surface of the block including the steel sheet being a measurement target for the surface roughness Ra(S); and a roughness adjusting step that adjusts surface roughness of the block facing end surface when the ratio Ra(D)/Ra(S) of surface roughness Ra(D) measured by the second roughness measuring step to Ra(S) measured by the first roughness measuring step does not satisfy 1<Ra(D)/Ra(S)≤12, in which the surface roughness Ra(S) is surface roughness Ra (μm) in a direction of a main magnetic flux flowing through the steel sheet when the laminated core is excited, or surface roughness Ra (μm) in a rolling direction of the steel sheet, the surface roughness Ra(D) is surface roughness Ra (μm) in a laminating direction of the steel sheet, the block facing end surface is, of end surfaces of the block, an end surface that is located at a position facing the another block each other in the laminated core, at the roughness adjusting step, the surface roughness of the block facing end surface is adjusted so as to satisfy 1<Ra(D)/Ra(S)≤12 at each of at least one pair of the block facing end surfaces, and the pair of block facing end surfaces is the two block facing end surfaces that are arranged at positions facing each other.

### BRIEF DESCRIPTION OF DRAWINGS

FIG. 1 is a view illustrating one example of a laminated core.

FIG. 2A is a view that explains a first example of a measurement position of a laminating-direction surface roughness.

FIG. 2B is a view that explains a second example of the measurement position of the laminating-direction surface roughness.

FIG. 2C is a view that explains a third example of the measurement position of the laminating-direction surface roughness.

FIG. 2D is a view that explains a fourth example of the measurement position of the laminating-direction surface roughness.

FIG. 2E is a view that explains a fifth example of the measurement position of the laminating-direction surface roughness.

FIG. 3A is a view that explains a first example of a measurement position of an in-plane-direction surface roughness.

FIG. 3B is a view that explains a second example of the measurement position of the in-plane-direction surface roughness.

FIG. 3C is a view that explains a third example of the measurement position of the in-plane-direction surface roughness.

FIG. 3D is a view that explains a fourth example of the measurement position of the in-plane-direction surface roughness.

FIG. 3E is a view that explains a fifth example of the measurement position of the in-plane-direction surface roughness.

FIG. 4A is a view that explains a first example of the number of crystal grains on a steel sheet facing end surface and the length of the steel sheet facing end surface.

FIG. 4B is a view that explains a second example of the number of crystal grains on the steel sheet facing end surface and the length of the steel sheet facing end surface.

FIG. 4C is a view that explains a third example of the number of crystal grains on the steel sheet facing end surface and the length of the steel sheet facing end surface.

FIG. 4D is a view that explains a fourth example of the number of crystal grains on the steel sheet facing end surface and the length of the steel sheet facing end surface.

FIG. 4E is a view that explains a fifth example of the number of crystal grains on the steel sheet facing end surface and the length of the steel sheet facing end surface.

FIG. 5 is a flowchart illustrating one example of a manufacturing method of a laminated core.

### DESCRIPTION OF EMBODIMENTS

Hereinafter, there will be explained one embodiment of the present invention with reference to the drawings.

Incidentally, the fact that objects to be compared such as lengths, positions, sizes, and intervals, are the same includes the case where they are strictly the same, as well as the case where they are different within a range that does not depart from the gist of the invention (for example, the case where they are different within a tolerance range defined at the time of design).

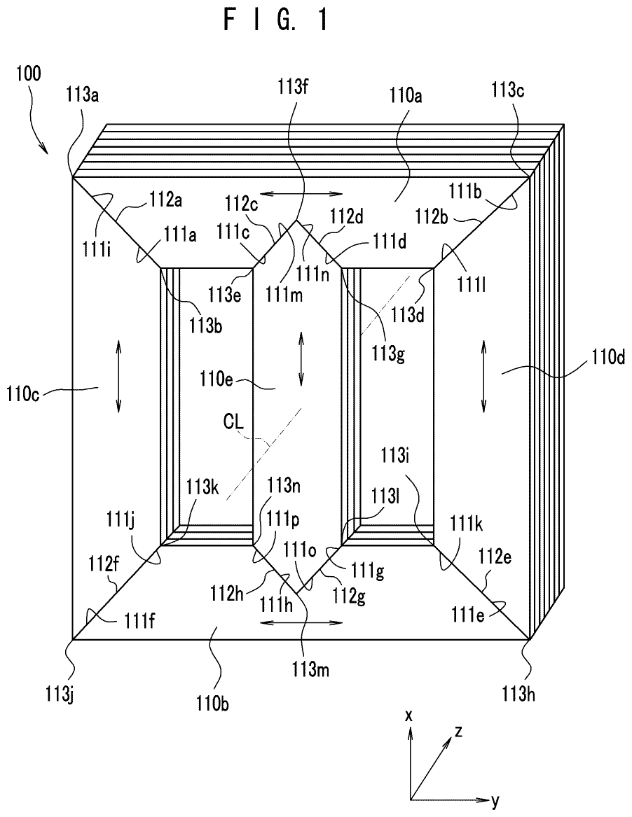

FIG. 1 is a view illustrating one example of a laminated core 100, Incidentally, the x-y-z coordinates illustrated in FIG. 1 are illustrated for the sake of convenience in explaining the orientation of each part. The laminated core 100 illustrated in FIG. 1 is a laminated core around which a coil through which, for example, a three-phase alternating current flows is wound (what is called a three-phase laminated core). Incidentally, the current to flow through the coil wound around the laminated core 100 is not limited to the three-phase alternating current. For example, the current to flow through the coil wound around the laminated core 100 may be a single-phase alternating current. Further, the laminated core 100 is also used as a core provided in various devices. The laminated core 100 may be, for example, a core provided in a transformer, a current transformer, a rotary electric machine, and a reactor.

In FIG. 1, the laminated core 100 includes a plurality of blocks 110a to 110e, The plural blocks 110a to 110e each include a plurality of steel sheets laminated with their sheet surfaces facing each other.

In FIG. 1, the double-headed arrow lines illustrated in the plural blocks 110a to 110e indicate the direction of a main magnetic flux to flow through the steel sheets when these blocks 110a to 110e are excited, or the rolling direction. In the following explanation, the direction of the main magnetic flux to flow through the steel sheets when the blocks 110a to 110e are excited is referred to as a main magnetic flux direction as necessary.

Incidentally, the main magnetic flux direction is determined by excluding, from the main magnetic fluxes flowing in the respective blocks, the main magnetic flux in the region where the direction changes due to flow in and out of other blocks (namely, the main magnetic flux direction is the direction in which the main magnetic flux travels straight). When the steel sheet is a single grain-oriented electrical steel sheet, it is preferable that the main magnetic flux direction and the rolling direction should be as close as possible, and it is more preferable that they should coincide with each other. Further, when the steel sheet is a single grain-oriented electrical steel sheet, it is preferable that the rolling direction and . . . the direction of easy magnetization (direction parallel to the axis of easy magnetization) should be as close as possible, and it is more preferable that they should coincide with each other.

In the following explanation, the case where the steel sheets are laminated so as to make the directions of the double-headed arrow lines in the plural blocks 110a to 110e substantially parallel (preferably parallel) to the rolling direction of the steel sheets means that the main magnetic flux direction (or rolling direction) may be either the main magnetic flux direction or the rolling direction. On the other hand, the case where the steel sheets are not laminated so as to make the directions of the double-headed arrow lines in the plural blocks 110a to 110e substantially parallel (preferably parallel) to the rolling direction of the steel sheets means that the main magnetic flux direction (or rolling direction) is the main magnetic flux direction. The rolling direction can be easily identified by observing the sheet surface of the steel sheet.

In this embodiment, the laminated core 100 is configured to have a twofold symmetric relationship with its center line CL set as the axis of rotational symmetry. The center line CL is a virtual straight line that passes through the position of the center of gravity of the laminated core 100 and extends in the laminating direction (z-axis direction) of the steel sheets that form the laminated core 100, In the following explanation, the laminating direction of the steel sheets that form the laminated core 100 is abbreviated to a laminating direction as necessary.

Further, in this embodiment, there is explained, as an example, the case where the plural blocks 110a to 110e are formed by laminating a plurality of single grain-oriented electrical steel sheets that are the same in material type and sheet thickness. However, the steel sheets are not limited to the single grain-oriented electrical steel sheet. The steel sheets may be, for example, a double grain-oriented electrical steel sheet. Further, the steel sheets may also be a non-oriented electrical steel sheet. Further, at least one of the material types and the sheet thicknesses of the steel sheets forming at least two of the plural blocks may be different. Further, at least one of the material types and the sheet thicknesses of the plural steel sheets forming one block may be different. Further, in this embodiment, there is explained, as an example, the case where the thicknesses (lengths in the laminating direction (z-axis direction)) of the plural blocks 110a to 110e are the same. Further, in this embodiment, there is explained, as an example, the case where the blocks 110a to 110b are configured and arranged so as to have a twofold symmetric relationship with the center line CL set as the axis of rotational symmetry. Similarly, there is explained, as an example, the case where the blocks 110c to 110d are also configured and arranged so as to have a twofold symmetric relationship with the center line CL set as the axis of rotational symmetry.

Incidentally, the number, shape, size, and arrangement of the blocks are determined according to the specifications of a device including the laminated core, Therefore, the number, shape, size, and arrangement of the blocks are not limited to those illustrated in FIG. 1, as an example.

The end surfaces of the plural blocks 110a to 110e include block facing end surfaces 111a to 111p. The block facing end surfaces 111a to 111p of the blocks 110a to 110e are end surfaces located at positions facing another block each other of the end surfaces of the blocks 110a to 110e. In the example illustrated in FIG. 1, the end surface of the block 110a includes the block facing end surfaces 111a to 111d. Further, the end surface of the block 110b includes the block facing end surfaces 111e to 111h. Further, the end surface of the block 110c includes the block facing end surfaces 111i to 111j. Further, the end surface of the block 110d includes the block facing end surfaces 111k to 111l. Further, the end surface of the block 110e includes the block facing end surfaces 111o to 111p.

Two block facing end surfaces arranged at positions facing each other are referred to as a pair of block facing end surfaces. For example, the block facing end surface 111a included in the block 110a and the block facing end surface 111i included in the block 110c are arranged at positions facing each other. Thus, these block facing end surfaces 111a and 111i are a pair of block facing end surfaces 111a and 111i. The laminated core 100 illustrated in FIG. 1 includes eight pairs of block facing end surfaces 111a and 111i, 111b and 111l, 111c and 111m, 111d and 111n, 111e and 111k, 111f and 111j, 111g and 111o, and 111h and 111p. Here, a pair of block facing end surfaces (for example, the block facing end surfaces 111a and 111i) is what is called a butt part. Thus, part or all of the regions of the pair of block facing end surfaces (two block facing end surfaces) is in contact with each other.

In FIG. 1, the block facing end surfaces 111a to 111p are delimited by bending points to appear when the lines indicating the block facing end surfaces 111a to 111p to be seen when the laminated core 100 is viewed from the laminating direction (z-axis direction) are linearly approximated (see the block facing end surfaces 111c and 111d, 111g and 111h, 111m and 111n, and 111o and 111p).

Incidentally, when the lines indicating the block facing end surfaces 111a to 111p to be seen when the laminated core 100 is viewed from the laminating direction (z-axis direction) can be approximated with higher accuracy by curve approximation (for example, approximation with a quadratic function) rather than by the straight line approximation, the block facing end surfaces may be delimited by the positions indicating . . . the extreme values when the curve approximation is performed.

There is explained the laminated core 100 in this embodiment below along with the findings found by the present inventors. To make the explanation easier to understand, the findings found by the present inventors are explained here using the symbols illustrated in FIG. 1. However, the findings found by the present inventors are not the findings limited to the laminated core 100 illustrated in FIG. 1.

Vibrations at the butt parts (block facing end surfaces 111a to 111p) of the blocks 110a to 110e have a significant impact on the noise of the laminated core 100. The present inventors focused on the shape of the steel sheet in order to inhibit such vibrations at the butt parts of the blocks 110a to 110e without using a material different from the steel sheet. Then, the present inventors have found out that by optimizing the roughnesses of the block facing end surfaces 111a to 111p, the vibrations at the butt parts (block facing end surfaces 111a to 111p) of the blocks 110a to 110e are inhibited, thereby making it possible to inhibit the noise of the laminated core 100.

Specifically, the present inventors have found out that at each of at least one pair of block facing end surfaces (two block facing end surfaces) of the plural pairs of block facing end surfaces 111a and 111i, 111b and 111l, 111c and 111m, 111d and 111n, 111e and 111k, 111f and 111j, 111g and 111o, and 111h and 111p, (1) Expression below is satisfied, thereby making it possible to inhibit vibration at the butt part (block facing end surfaces) of the block.

1<Ra(D)/Ra(S)≤12 (1)

Here, Ra(D) is surface roughness Ra (μm) in the laminating direction (z-axis direction) of one block facing end surface of the pair of block facing end surfaces (two block facing end surfaces) being a calculation target for (1) Expression. In the following explanation, the surface roughness to be determined at each of the block facing end surfaces as above is referred to as laminating-direction surface roughness as necessary. Further, Ra(S) is surface roughness Ra (μm) in the main magnetic flux direction of the sheet surface of the steel sheet having an end surface that forms part of the block facing end surface (or the rolling direction of the steel sheet). In the following explanation, the surface roughness to be determined as above is referred to as in-plane-direction surface roughness as necessary. The surface roughnesses Ra (laminating-direction surface roughness Ra(D) and in-plane-direction surface roughness Ra(S)) are each set to be a mean height Re of roughness curve elements defined in JIS B 0601:2013, Incidentally, the block facing end surface is composed of end surfaces of the plural laminated steel sheets. The end surface that forms part of the block facing end surface is an end surface of one of the plural steel sheets. Further, (φm) in Ra (μm) indicates that the unit of the surface roughness Ra is micrometers (such a method of expressing units is the same for the other variables n, L, and n/L). The in-plane-direction surface roughness Ra(S) is, for example, 0.10 μm or more and 3.00 μm or less.

For example, it is set that the pair of block facing end surfaces (two block facing end surfaces) being a calculation target for (1) Expression is the pair of block facing end surfaces 111a and 111i. In this case, as long as at each of the block facing end surfaces 111a and 111i, (1) Expression is satisfied, at each of one pair of block facing end surfaces 111a and 111i, (1) Expression is satisfied. Also at the other pairs of block facing end surfaces 111b and 111l, 111c and 111m, 111d and 111n, 111e and 111k, 111f and 111j, 111g and 111o, 111h and 111p, whether or not to satisfy (1) Expression is determined in the same manner.

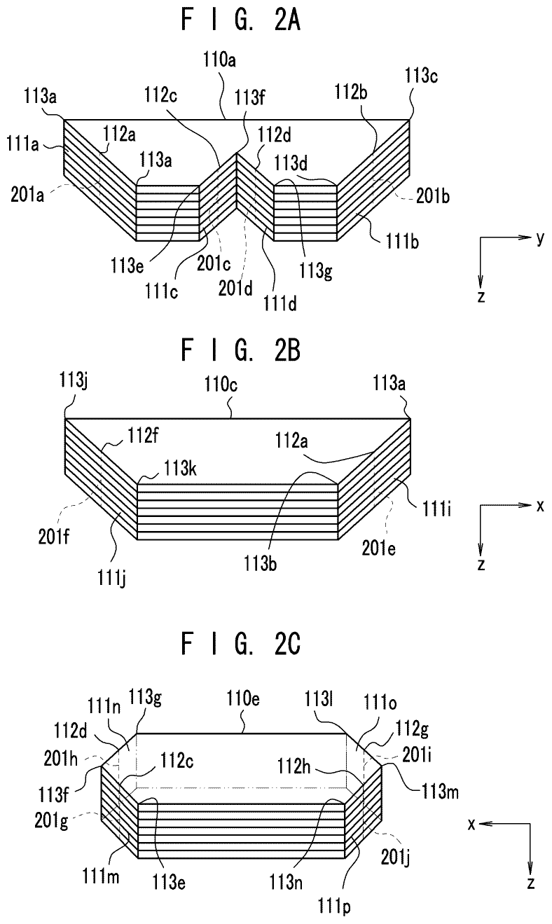

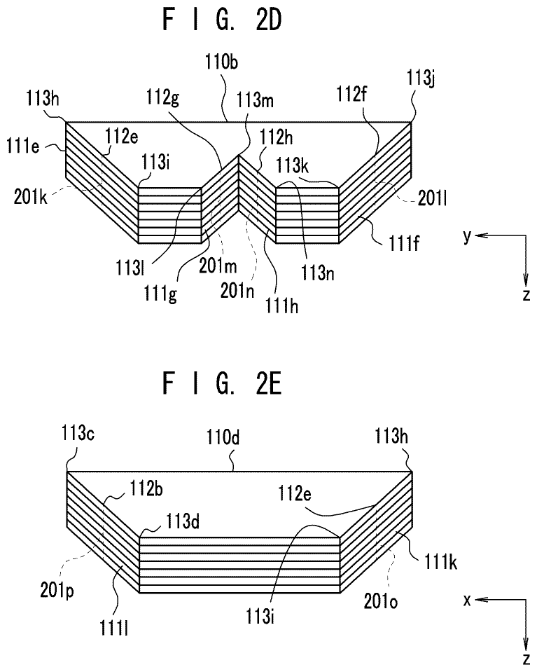

FIG. 2A to FIG. 2E are views each explaining one example of a measurement position of the laminating-direction surface roughness Ra(D). The y-z coordinates illustrated in FIG. 2A and FIG. 2D correspond to the y coordinate and the z coordinate of the x-y-z coordinates illustrated in FIG. 1. The x-z coordinates illustrated in FIG. 2B, FIG. 2C, and FIG. 2E correspond to the x coordinate and the z coordinate of the x-y-z coordinates illustrated in FIG. 1. As described previously, the block 110a illustrated in FIG. 2A and the block 110b illustrated in FIG. 2D are configured and arranged to have a twofold symmetric relationship with the center line CL of the laminated core 100 set as the axis of rotational symmetry. Similarly, the block 110c illustrated in FIG. 2B and the block 110d illustrated in FIG. 2D are also configured and arranged to have a twofold symmetric relationship with the center line CL of the laminated core 100 set as the axis of rotational symmetry,

FIG. 2A and FIG. 2D are views illustrating one example of the measurement position of the laminating-direction surface roughness Ra(D) of the block facing end surfaces 111a to 111d and 111e to 111h included in the blocks 110a and 110b. FIG. 2B and FIG. 2E are views illustrating one example of the measurement position of the laminating-direction surface roughness Ra(D) of the block facing end surfaces 111i to 111j and 111k to 111l included in the blocks 110c and 110d. FIG. 2C is a view illustrating one example of the measurement position of the laminating-direction surface roughness Ra(D) of the block facing end surfaces 111m to 111p included in the block 110e.

The laminating-direction surface roughness Ra(D) is measured, at a pair of block facing end surfaces being a calculation target for (1) Expression, on a virtual straight line passing through the middle position between both ends of the block facing end surface when the block facing end surface is viewed from the laminating direction of the steel sheet having an end surface that forms part of the block facing end surface,

In the example illustrated in FIG. 1, the laminating direction of the steel sheets having end surfaces that form part of the block facing end surfaces 111a to 111p is the z-axis direction. In FIG. 1, the middle positions between both ends 113a and 113b, between both ends 113c and 113d, between both ends 113e and 113f, between both ends 113f and 113g, between both ends 113h and 113i, between both ends 113j and 113k, between both ends 113e and 113f, between both ends 113f and 113g, between both ends 113l and 113m, and between both ends 113m and 113n of the block facing end surfaces 111a and 111i, 111b and 111l, 111c and 111m, 111d and 111n, 111e and 111k, 111f and 111j, 111g and 111o, and 111h and 111p when these block facing end surfaces are viewed in the z-axis direction are positions 112a, 112b, 112c, 112d, 112e, 112f, 112g, and 112h respectively. The middle position of both ends of the block facing end surface is obtained at each of the steel sheets in the laminating direction (z-axis direction). By tracing such middle positions of both ends of these block facing end surfaces, virtual straight lines 201a to 201p are obtained, as illustrated in FIG. 2A to FIG. 2B.

Therefore, when the pair of block facing end surfaces being a calculation target for (1) Expression is the pair of block facing end surfaces 111a and 111i, as illustrated in FIG. 2A and FIG. 2B, the laminating-direction surface roughnesses Ra(D) of the block facing end surfaces 111a and 111i are measured on the virtual straight lines 201a and 201e respectively. Further, when the pair of block facing end surfaces being a calculation target for (1) Expression is the pair of block facing end surfaces 111b and 111l, as illustrated in FIG. 2A and FIG. 2E, the roughness curves for calculating the laminating-direction surface roughnesses Ra(D) of the block facing end surfaces 111b and 111l are measured on the virtual straight lines 201b and 201p respectively. Further, when the pair of block facing end surfaces being a calculation target for (1) Expression is the pair of block facing end surfaces 111c and 111m, as illustrated in FIG. 2A and FIG. 2C, the roughness curves for calculating the laminating-direction surface roughnesses Ra(D) of the block facing end surfaces 111c and 111m are measured on the virtual straight lines 201c and 201g respectively. Further, when the pair of block facing end surfaces being a calculation target for (1) Expression is the pair of block facing end surfaces 111d and 111n, as illustrated in FIG. 2A and FIG. 2C, the roughness curves for calculating the laminating-direction surface roughnesses Ra(D) of the block facing end surfaces 111d and 111n are measured on the virtual straight lines 201d and 201h respectively.

Regarding the other pairs of block facing end surfaces 111e and 111k, 111f and 111j, 111g and 111o, and 111h and 111p, similarly, the roughness curves for calculating the laminating-direction surface roughnesses Ra(D) are measured on the virtual straight lines 201k and 201o, the virtual straight lines 201l and 201f, the virtual straight lines 201m and 201i, and the virtual straight lines 201n and 201j respectively.

In the following explanation, the positions on the virtual straight lines 201a to 201p where the roughness curve (roughness curve element) for calculating the laminating-direction surface roughness Ra(D) is measured are referred to as laminating-direction measurement positions as necessary. In the laminated core 100 illustrated in FIG. 1 as an example, the laminating-direction measurement positions are the positions of bevel cut surfaces as illustrated in FIG. 2A to FIG. 2E.

The plural steel sheets forming one block facing end surface of the pair of block facing end surfaces being a calculation target for (1) Expression are extracted one by one, and then the laminating-direction surface roughness Ra(D) of the extracted steel sheet is measured at the laminating-direction measurement position. Alternatively, the laminating-direction surface roughness Ra(D) may be measured at the laminating-direction measurement position of the pre-laminated steel sheet that is used to form the block including the one block facing end surface. This measurement is performed for each of all of the steel sheets that form the one block facing end surface. For example, when the number of laminated sheets is 200, 200 laminating-direction surface roughnesses Ra(D) are measured for one block facing end surface. The representative value of the plural (200 in the previously-described example) laminating-direction surface roughnesses Ra(D) measured in the above manner is set as the laminating-direction surface roughness Ra(D) of the one block facing end surface. The representative value is, for example, an arithmetic mean value. The median value or the like may be used in place of the arithmetic mean value. The laminating-direction surface roughness Ra(D) of the other block facing end surface of the pair of block facing end surfaces being a calculation target for (1) Expression is also calculated in the same manner as the block facing end surface Ra(D) of the one block facing end surface.

The laminating-direction surface roughnesses Ra(D) of one and the other of a pair of block facing end surfaces are calculated as above at each of the block facing end surfaces 111a and 111i, the block facing end surfaces 111b and 111i, the block facing end surfaces 111c and 111m, the block facing end surfaces 111d and 111n, the block facing end surfaces 111e and 111k, the block facing end surfaces 111f and 111j, the block facing end surfaces 111g and 111o, and the block facing end surfaces 111h and 111p.

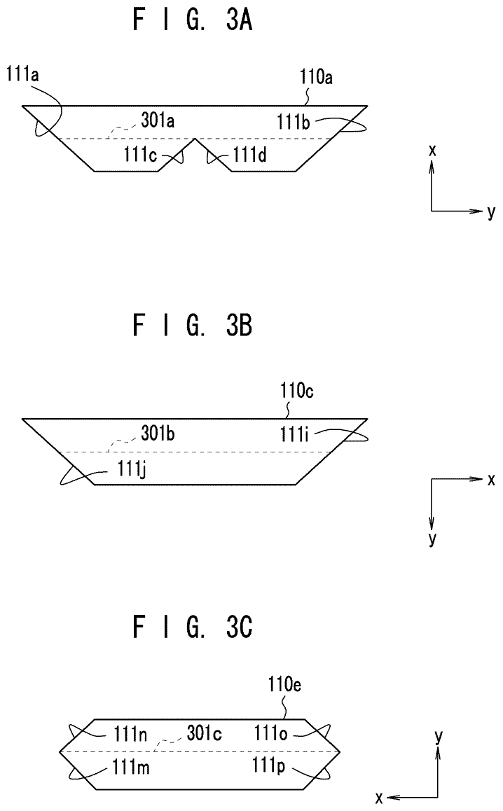

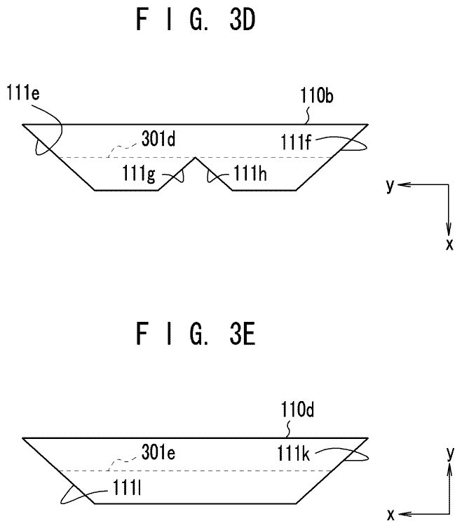

FIG. 3A to FIG. 3E are views each illustrating one example of a measurement position of a roughness curve for calculating the in-plane-direction surface roughness Ra(S). The x-y coordinates illustrated in FIG. 3A to FIG. 3E correspond to the x coordinate and the y coordinate of the x-y-z coordinates illustrated in FIG. 1.

FIG. 3A and FIG. 3D are views illustrating one example of the measurement position of the roughness curve for calculating the in-plane-direction surface roughness Ra(S) of the steel sheets having end surfaces that form part of the block facing end surfaces 111a to 111d and 111e to 111h included in the blocks 110a and 110b. FIG. 3B and FIG. 3E are views illustrating one example of the measurement position of the roughness curve for calculating the in-plane-direction surface roughness Ra(S) of the steel sheets having end surfaces that form part of the block facing end surfaces 111i to 111j and 111k to 111i included in the blocks 110c and 110d, FIG. 3C is a view illustrating one example of the measurement position of the roughness curve for calculating the in-plane-direction surface roughness Ra(S) of the steel sheets having end surfaces that form part of the block facing end surfaces 111m to 111p included in the block 110e.

Here, the direction vertical to the main magnetic flux direction (or rolling direction) and the laminating direction of the steel sheet is referred to as the width direction as necessary. The roughness curve for calculating the in-plane-direction surface roughness Ra(S) is measured, at a sheet surface of the steel sheet having an end surface that forms part of a pair of block facing end surfaces being a calculation target for (1) Expression, on a virtual straight line that passes through the middle position in the width direction of the steel sheet and extends along the main magnetic flux direction (or rolling direction) of the steel sheet.

In the example illustrated in FIG. 1, the laminating direction of the steel sheets having end surfaces that form part of the block facing end surfaces 111a to 111p is the z-axis direction. Further, the main magnetic flux direction (or rolling direction) of the steel sheets that form part of the block facing end surfaces 111a to 111d and 111e to 111h is the y-axis direction (the direction of the double-headed arrow line illustrated in FIG. 1). Further, the width direction of the steel sheets that form part of the block facing end surfaces 111a to 111d and 111e to 111h is the x-axis direction. The main magnetic flux direction (or rolling direction) of the steel sheets that form part of the block facing end surfaces 111i to 111j, 111k to 111i, and 111m to 111p is the x-axis direction (the direction of the double-headed arrow line illustrated in FIG. 1). Further, the width direction of the steel sheets that form part of the block facing end surfaces 111i to 111j, 111k to 111l, and 111m to 111p is the y-axis direction.

In this case, in FIG. 3A, the virtual straight line passing through the middle position in the width direction (x-axis direction) of the steel sheet having end surfaces that form part of the block facing end surfaces 111a to 111d and extending along the main magnetic flux direction (or rolling direction, y-axis direction) of the steel sheet is a virtual straight line 301a. Similarly, in FIG. 3D, the virtual straight line passing through the middle position in the width direction (x-axis direction) of the steel sheet having end surfaces that form part of the block facing end surfaces 111e to 111h and extending along the main magnetic flux direction (or rolling direction, y-axis direction) of the steel sheet is a virtual straight line 301d.

Further, in FIG. 3B, the virtual straight line passing through the middle position in the width direction (y-axis direction) of the steel sheet having end surfaces that form part of the block facing end surfaces 111i to 111j and extending along the main magnetic flux direction (or rolling direction, x-axis direction) of the steel sheet is a virtual straight line 301b. Similarly, in FIG. 3E, the virtual straight line passing through the middle position in the width direction (y-axis direction) of the steel sheet having end surfaces that form part of the block facing end surfaces 111k to 111l and extending along the main magnetic flux direction (or rolling direction, x-axis direction) of the steel sheet is a virtual straight line 301e.

Further, in FIG. 3C, the virtual straight line passing through the middle position in the width direction (y-axis direction) of the steel sheet having end surfaces that form part of the block facing end surfaces 111m to 111p and extending along the main magnetic flux direction (or rolling direction, x-axis direction) of the steel sheet is a virtual straight line 301c.

Therefore, as illustrated in FIG. 3A and FIG. 3D, the roughness curves for calculating the in-plane-direction surface roughnesses Ra(S) of the steel sheets having end surfaces that form part of the block facing end surfaces 111a to 111d and 111e to 111h are measured on the virtual straight lines 301a and 301d respectively. Further, as illustrated in FIG. 3B and FIG. 3E, the roughness curves for calculating the in-plane-direction surface roughnesses Ra(S) of the steel sheets having end surfaces that form part of the block facing end surfaces 111i to 111j and 111k to 111l are measured on the virtual straight lines 301b and 301e respectively. Further, as illustrated in FIG. 3C, the roughness curve for calculating the in-plane-direction surface roughness Ra(S) of the steel sheet having end surfaces that form part of the block facing end surfaces 111m to 111p is measured on the virtual straight line 301c.

Incidentally, when determining the measurement position (virtual straight line) of the roughness curve for calculating the in-plane-direction surface roughness Ra(S) as described above, this virtual straight line is divided into a plurality of lines depending on the shape of the steel sheet in some cases. In this case, the roughness curve is measured on any one of the plural divided virtual straight lines. Further, the roughness curve may be measured on the plural virtual straight lines as if these plural virtual straight lines were not divided (namely, as if each spacing between the plural virtual straight lines was 0 (zero)).

In the following explanation, the positions of the virtual straight lines 301a to 301e where the roughness curve (roughness curve element) for calculating the in-plane-direction surface roughness Ra(S) is measured are referred to as in-plane-direction measurement positions as necessary.

The plural steel sheets forming one block facing end surface of the pair of block facing end surfaces being a calculation target for (1) Expression are extracted one by one, and then the in-plane-direction surface roughness Ra(s) of the extracted steel sheet is measured at the in-plane-direction measurement position. Alternatively, the in-plane-direction surface roughness Ra(S) may be measured at the in-plane-direction measurement position of the pre-laminated steel sheet that is used to form the block including the one block facing end surface. This measurement is performed for each of all of the steel sheets that form the one block facing end surface. For example, when the number of laminated sheets is 200, 200 in-plane-direction surface roughnesses Ra(S) are measured for one block facing end surface. The representative value of the plural (200 in the previously-described example) in-plane-direction surface roughnesses Ra(S) measured in the above manner is set as the in-plane-direction surface roughness Ra(S) of the one block facing end surface. The representative value is, for example, an arithmetic mean value. The median value or the like may be used in place of the arithmetic mean value. The in-plane-direction surface roughness Ra(S) of the other block facing end surface of the pair of block facing end surfaces being a calculation target for (1) Expression is also calculated in the same manner as the in-plane-direction surface roughness Ra(S) of the one block facing end surface.

The in-plane-direction surface roughnesses Ra(S) of one and the other of a pair of block facing end surfaces are calculated as above at each of the block facing end surfaces 111a and 111i, the block facing end surfaces 111b and 111l, the block facing end surfaces 111c and 111m, the block facing end surfaces 111d and 111n, the block facing end surfaces 111e and 111k, the block facing end surfaces 111f and 111j, the block facing end surfaces 111g and 111o, and the block facing end surfaces 111h and 111p.

As described previously, to calculate the laminating-direction surface roughness Ra(D) and the in-plane-direction surface roughness Ra(S), for example, the roughness curve (roughness curve element) is measured. The roughness curve (roughness curve element) is measured, for example, for each of the plural steel sheets that form one block facing end surface. Further, the roughness curve (roughness curve element) is measured at each of the laminating-direction measurement position and the in-plane-direction measurement position.

For example, when the number of laminated sheets is 200, 200 roughness curves (roughness curve elements) are measured for one block facing end surface as the roughness curve (roughness curve element) for calculating the laminating-direction surface roughness Ra(D). The representative value of the plural (200 in the previously-described example) roughness curves measured in the above manner is set as the roughness curve for calculating the laminating-direction surface roughness Ra(D) of the one block facing end surface. Incidentally, the representative value of the plural (200 in the previously-described example) roughness curves is calculated by calculating the representative value of the values at the same positions in the sheet thickness direction for each of the plural roughness curves. The representative value is, for example, an arithmetic mean value. The median value or the like may be used in place of the arithmetic mean value. Further, when the plural steel sheets have different sheet thicknesses, for example, a roughness curve obtained by connecting the plural (200 in the previously-described example) roughness curves may be used as the roughness curve (roughness curve element) for calculating the laminating-direction surface roughness Ra(D).

The roughness curve for calculating the in-plane-direction surface roughness Ra(S) is measured for each of all of the steel sheets having end surfaces that form part of one block facing end surface, for example. For example, when the number of laminated sheets is 200, 200 roughness curves are measured as the roughness curve for calculating the in-plane-direction surface roughness Ra(S) for one block facing end surface. The representative value of the plural (200 in the previously-described example) roughness curves measured in the above manner is set as the roughness curve for calculating the in-plane-direction surface roughness Ra(S) of the steel sheet having an end surface that forms part of the block facing end surface. The representative value of the plural roughness curves can be obtained, for example, by calculating an arithmetic mean value of the values at the positions where the positions (x-coordinates and γ-coordinates) in the sheet surface direction are the same. The representative value is, for example, an arithmetic mean value. The median value or the like may be used in place of the arithmetic mean value. For measuring the roughness curve (roughness curve element), for example, a one-shot 3D shape measuring machine (model name: VR-6000) manufactured by KEYENCE CORPORATION may be used. Regarding the measurement field of view, the measurement magnification is set to, for example, 200 times so that the size of one field of view is, for example, 500 μm×500 μm. When measuring the mean height of the roughness curve elements with a digital microscope, the vibration of the steel sheet during measurement may be corrected by establishing a cutoff value λs=0 μm and a cutoff value λc=0 mm. The measurement magnification is preferably 100 times or more, and more preferably 500 times to 700 times.

The in-plane-direction surface roughness Ra(S) and the laminating-direction surface roughness Ra(D) calculated for the same block facing end surface are used to calculate Ra(D)/Ra(S). Then, whether or not the calculated Ra(D)/Ra(S) satisfies (1) Expression is checked.

The method for satisfying (1) Expression may be any method as long as it is capable of adjusting the roughness of the end surface of the steel sheet. The roughness of the end surface of the steel sheet is adjusted, for example, by any one of grinding, cutting, and polishing.

For example, when cutting steel sheets to obtain the planar shapes (shapes of the x-y plane illustrated in FIG. 1) of the blocks 110a to 110e, the roughness of the end surface of each of the steel sheets may be adjusted. Further, the roughness of the end surface of each of the steel sheets cut into the planar shapes of the blocks 110a to 110e may be adjusted. For example, when shearing each of the steel sheets, the roughness of the end surface of each of the steel sheets may be adjusted by controlling the clearance between upper and lower blades of a shearing machine. Further, after laminating the plural steel sheets, the roughnesses of the end surfaces corresponding to the block facing end surfaces 111a to 111p may be adjusted. Further, any two or more of these methods may be combined.

Then, after laminating the plural steel sheets, at the end surfaces corresponding to the block facing end surfaces 111a to 111p, whether or not to satisfy (1) Expression may be checked. Then, when (1) Expression is not satisfied, the roughnesses of these end surfaces may be readjusted. Further, after the laminated steel sheets are separated, the roughness of the end surface of each of the steel sheets may be readjusted. Further, at the end surfaces corresponding to the block facing end surfaces 111a to 111p, whether or not to satisfy (1) Expression may be checked after the plural steel sheets are laminated without adjusting the roughnesses of the end surfaces of the steel sheets before laminating the plural steel sheets. Then, when (1) Expression is not satisfied, the roughnesses of the end surfaces may be adjusted so as to satisfy (1) Expression.

It is thought that satisfying (1) Expression makes it possible to apply, when the laminated core 100 is excited, a coupling force, which acts to attract adjacent steel sheets in the laminating direction (z-axis direction) to each other at the block facing end surfaces 111a to 111p, to the butt parts (block facing end surfaces 111a to 111p) of the blocks 110a to 110e and their nearby regions. In (1) Expression, when Ra(D)/Ra(S) is less than 1 (Ra(D)/Ra(S)<1), the roughnesses of the block facing end surfaces 111a to 111p become too small (become close to a flat state). Therefore, it is thought that it is impossible to apply the previously-described coupling force to the butt parts (block facing end surfaces 111a to 111p) of the blocks 110a to 110e and their nearby regions. On the other hand, when Ra(D)/Ra(S) exceeds 12 (Ra(D)/Ra(S)>12), it is thought that the previously-described coupling force becomes too strong, thus introducing an excessive compressive stress into the steel sheets, and this compressive stress causes the butt parts (block facing end surfaces 111a to 111p) of the blocks 110a to 110e to vibrate.

Further, the present inventors have found out that, from the viewpoint of more reliably increasing the effect of inhibiting noise of the laminated core 100, it is more preferable to use (2) Expression below in place of (1) Expression.

6≤Ra(D)/Ra(S)≤8 (2)

As described previously, at each of at least one of these pairs of block facing end surfaces 111a and 111i, 111b and 111l, 111c and 111m, 111d and 111n, 111e and 111k, 111f and 111j, 111g and 111o, and 111h and 111p, (1) Expression (and further (2) Expression preferably) only need to be satisfied. However, it is preferable to satisfy (1) Expression (and further (2) Expression preferably) at each block facing end surface of two or more pairs of these pairs of block facing end surfaces. Further, it is more preferable to satisfy (1) Expression (and further (2) Expression preferably) at each block facing end surface of the pairs of block facing end surfaces, which are equal to or more than ½ times the total number of these pairs of block facing end surfaces (8 in the example illustrated in FIG. 1), Further, it is even more preferable to satisfy (1) Expression (and further (2) Expression preferably) at each block facing end surface of all of the pairs of block facing end surfaces.

Further, the present inventors focused on the crystal grains of the steel sheets in order to inhibit vibrations at the butt parts (block facing end surfaces) of the blocks 110a to 110e without using a material different from the steel sheets. Here, the end surface of a steel sheet having an end surface that forms part of the block facing end surfaces 111a to 111p is referred to as the steel sheet facing end surface, as necessary. Further, among the crystal grains present in the steel sheet having a steel sheet facing end surface, the number of crystal grains including the steel sheet facing end surface as a boundary is referred to as the number of crystal grains on the steel sheet facing end surface, as necessary. Further, the value obtained by dividing the number of crystal grains on the steel sheet facing end surface by the length of the steel sheet facing end surface is referred to as the number of crystal grains per unit length on the steel sheet facing end surface, as necessary. Here, the number of crystal grains on the steel sheet facing end surface is set as n (grains). Further, the length of the steel sheet facing end surface is set as L (mm). Then, the number of crystal grains per unit length on the steel sheet facing end surface is n/L (grains/mm).

The present inventors investigated the relationship between the number of crystal grains per unit length on the steel sheet facing end surface n/L and the noise level of the laminated core 100. At that time, the number of crystal grains per unit length on the steel sheet facing end surface n/L was calculated as follows, First, of the pairs of block facing end surfaces 111a and 111i, 111b and 111l, 111c and 111m, 111d and 111n, 111e and 111k, 111f and 111j, 111g and 111o, and 111h and 111p, the number of crystal grains per unit length on the steel sheet facing end surface n/L of each of all of the steel sheets having end surfaces that form part of one of the block facing end surfaces was calculated. Then, the arithmetic mean value of the calculated numbers of crystal grains per unit length on the steel sheet facing end surface n/L was calculated as the number of crystal grains per unit length on the steel sheet facing end surface n/L at the one block facing end surface. As a result of calculating the number of crystal grains per unit length on the steel sheet facing end surface n/L in this manner, the present inventors have found out that the noise level of the laminated core 100 begins to change significantly due to vibrations at the butt parts (block facing end surfaces 111a to 111p) of the blocks 110a to 110e when the number of crystal grains per unit length on the steel sheet facing end surface n/I reaches 0.5 (grains/mm). When the number of crystal grains per unit length on the steel sheet facing end surface n/L exceeds 0.5 (grains/mm), it is thought that it is not possible to sufficiently reduce the vibrations at the butt parts (block facing end surfaces 111a to 111p) of the blocks 110a to 110e because a lot of crystal grains each vibrate on the steel sheet facing end surface.

From this, the present inventors have found out that at at least one of the block facing end surfaces (preferably both of the block facing end surfaces) of the pairs of block facing end surfaces 111a and 111i, 111b and 111l, 111c and 111m, 111d and 111n, 111e and 111k, 111f and 111j, 111g and 111o, and 111h and 111p, (3) Expression below is satisfied, thereby making it possible to inhibit vibration of the laminated core 100.

n/L≤0.5 (3)

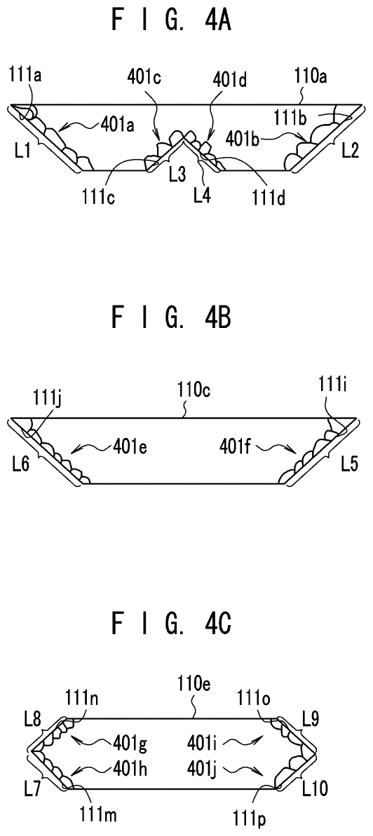

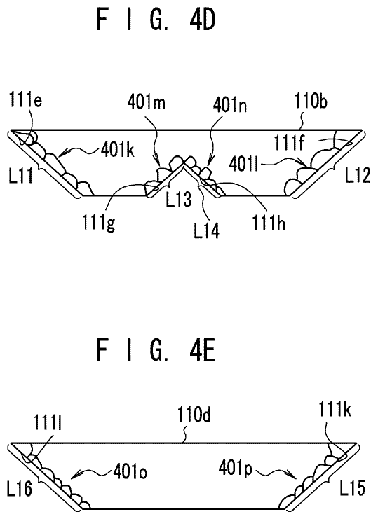

FIG. 4A to FIG. 4D are views each explaining one example of the number of crystal grains on the steel sheet facing end surface n and the length L of the steel sheet facing end surface.

FIG. 4A and FIG. 4D are views that explain the number of crystal grains n on the steel sheet facing end surface that forms part of the block facing end surfaces 111a to 111d and 111e to 111h included in the blocks 110a and 110b, and the length L of the steel sheet facing end surface. FIG. 4B and FIG. 4E are views that explain the number of crystal grains n on the steel sheet facing end surface that forms part of the block facing end surfaces 111i to 111j and 111k to 111l included in the blocks 110c and 110d, and the length L of the steel sheet facing end surface. FIG. 4C is a view that explains the number of crystal grains n on the steel sheet facing end surface that forms part of the block facing end surfaces 111m to 111p included in the block 110e, and the length L of the steel sheet facing end surface.

FIG. 4A illustrates an example of a crystal grain group 401a consisting of five crystal grains as, out of crystal grains present in one of the steel sheets having steel sheet facing end surfaces that form part of the block facing end surface 111a, the crystal grain including the steel sheet facing end surface as a boundary. In this case, the number of crystal grains n on the steel sheet facing end surface that forms part of the block facing end surface 111a is 5. As illustrated in FIG. 1 and FIG. 2A, as the steel sheet having a steel sheet facing end surface that forms part of the block facing end surface 111a, there are plural steel sheets present in the laminating direction (z-axis direction), Therefore, for each of the plural steel sheets, the number of crystal grains n on the steel sheet facing end surface that forms part of the block facing end surface 111a is counted. For example, when the block 110a includes 100 steel sheets and the number of crystal grains n on each of the steel sheet facing end surfaces of the 100 steel sheets that form part of the block facing end surface 111a is 5, the total value of the numbers of crystal grains n on the steel sheet facing end surfaces that form part of the block facing end surface 111a is 500 (=100×5).

The number of crystal grains n on the steel sheet facing end surface that forms part of each of the block facing end surfaces 111b to 111p other than the block facing end surface 111a is counted in the same manner. FIG. 4A to FIG. 4E illustrate crystal grain groups 401b, 401c, 401d, 401e, 401f, 401g, 401h, 401i, 401j, 401k, 401l, 401m, 401n, 401o, and 401p consisting of four, three, five, seven, six, five, four, four, three, five, four, three, five, seven, and a six crystal grains, respectively out of the crystal grains present in one of the steel sheets having steel sheet facing end surfaces that form part of the block facing end surfaces 111b, 111c, 111d, 111i, 111j, 111m, 111n, 111o, 111p, 111e, 111f, 111g, 111h, 111k, and 111l, as the crystal grain group including the steel sheet facing end surface as a boundary.

The method for counting the number of crystal grains on the steel sheet facing end surface n may be any method as long as it is capable of measuring the number of crystal grains. For example, the number of crystal grains on the steel sheet facing end surface n may be counted by performing observation with an electron microscope or an optical microscope as follows. First, the steel sheet facing end surface (cut surface) is corroded with a 5% nital solution for 100 to 300 seconds, and then crystal grain boundaries are observed with an optical microscope. As the optical microscope, for example, an industrial microscope BX53M manufactured by OLYMPUS CORPORATION may be used, Curved or straight lines extending from one sheet surface to the other sheet surface (for example, in the sheet thickness direction) when the steel sheet facing end surface (cut surface) is observed over the entire length in the longitudinal direction of the steel sheet facing end surface are uniformly defined as crystal grain boundaries. When the number of crystal grain boundaries defined in this manner is q in one steel sheet facing end surface (cut surface), q+1 becomes the number of crystal grains on the steel sheet facing end surface n (n=q+1) (q is a nonnegative integer). For example, when the number of crystal grain boundaries defined in this manner in one steel sheet facing end surface (cut surface) is 3, the number of crystal grains on that steel sheet facing end surface n is 4. If the number of crystal grain boundaries in one steel sheet facing end surface is 0 (zero) tentatively, the number of crystal grains on the steel sheet facing end surface n is 1 (=0+1).

Further, in FIG. 4A to FIG. 4E, the length L of the steel sheet facing end surface is the length of the steel sheet facing end surface to be seen when the steel sheet having the steel sheet facing end surface is viewed in a direction vertical to the sheet surface of the steel sheet (direction vertical to the paper in FIG. 4A to FIG. 4E). FIG. 4A illustrates that the length L of the steel sheet facing end surface that forms part of the block facing end surface 111a is a length L1. As illustrated in FIG. 1 and FIG. 2A, there are plural steel sheets in the laminating direction (z-axis direction), the steel sheets each having a steel sheet facing end surface that forms part of the block facing end surface 111a. Therefore, for each of the plural steel sheets, the length L of the steel sheet facing end surface that forms part of the block facing end surface 111a is measured.

The length L of each of the steel sheet facing end surfaces that form part of the block facing end surfaces 111b to 111p other than the block facing end surface 111a is measured in the same manner. FIG. 4A to FIG. 4E illustrate L2, L3, 14, 15, 16, 17, 18, 19, L10, L11, 112, L13, L14, L15, and L16 as the lengths L of the steel sheet facing end surfaces that form part of the block facing end surfaces 111b, 111c, 111d, 111i, 111j, 111m, 111n, 111o, 111p, 111e, 111f, 111g, 111h, 111k, and 111l, respectively.

The method for measuring the length L of the steel sheet facing end surface may be any method as long as it is capable of measuring the length of the end surface of the steel sheet. The length L of the steel sheet facing end surface may be measured by direct measurement using a vernier caliper or the like, for example. Further, the length L of the steel sheet facing end surface may also be measured by indirect measurement using image analysis or the like.

Incidentally, for example, the representative value (for example, the arithmetic mean value) of the number of crystal grains n on the steel sheet facing end surface that forms part of one block facing end surface and the representative value (for example, the arithmetic mean value) of the length L of the steel sheet facing end surface that forms part of the one block facing end surface may be used as n and L in (3) Expression respectively, to thereby check whether or not to satisfy (3) Expression. Further, the check whether or not to satisfy (3) Expression may be performed at each one of the steel sheet facing end surfaces.

In order to satisfy (3) Expression, it is necessary to control the size of crystal grains of the steel sheet during manufacture of the steel sheet. For example, at least one of the following may be controlled: the amount of nitriding during nitriding annealing for controlling precipitates and texture; and the annealing temperature and the holding time (relationship between annealing temperature and time) during batch annealing for causing secondary recrystallization, to thereby control the size of crystal grains of the steel sheet so as to satisfy (3) Expression. Specifically, at least one of the following may be performed: adjusting the flow rate of ammonia to be supplied to the atmosphere during nitriding annealing; adjusting (lengthening) the soaking time during batch annealing; and providing a retention time before reaching the soaking temperature during batch annealing and adjusting the retention time, to thereby control the size of crystal grains of the steel sheet so as to satisfy (3) Expression.

Satisfying (1) Expression (or (2) Expression) and (3) Expression makes it possible to inhibit vibrations at the butt parts (block facing end surfaces 111a to 111p) of the blocks 110a to 110e. As above, it is preferable to satisfy both (1) Expression (or (2) Expression) and (3) Expression. However, in order to satisfy (3) Expression, it is necessary to select the material of the steel sheet. Further, the burden of checking whether or not to satisfy (3) Expression is greater than the burden of checking whether or not to satisfy (1) Expression (or (2) Expression), Further, when (3) Expression is not satisfied, the steel sheet needs to be manufactured again. Therefore, from the viewpoint of simply inhibiting vibrations at the butt parts (block facing end surfaces 111a to 111p) of the blocks 110a to 110e, this embodiment may be configured to satisfy only (1) Expression (or (2) Expression).

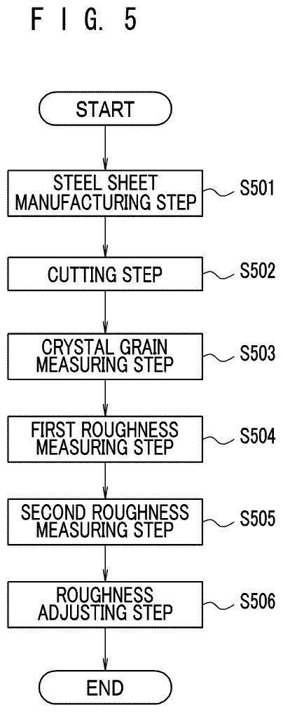

FIG. 5 is a flowchart illustrating one example of a manufacturing method of the laminated core 100 in this embodiment.

First, at Step S501, a steel sheet manufacturing step is performed. At the steel sheet manufacturing step, steel sheets that form the laminated core 100 are manufactured. A well-known method may be employed as the method of manufacturing the steel sheets. However, in this embodiment, the size of crystal grains of the steel sheet is controlled so as to satisfy (3) Expression. As described previously, the size of crystal grains of the steel sheet may be controlled by controlling the annealing conditions. Further, from the viewpoint of simply inhibiting vibrations at the butt parts (block facing end surfaces 111a to 111p) of the blocks 110a to 110e, when whether or not to satisfy (3) Expression is not determined, it is not necessary to control the size of crystal grains of the steel sheet so as to satisfy (3) Expression.

Next, at Step S502, a cutting step is performed. At the cutting step, the steel sheet manufactured at Step S501 is cut. In this embodiment, the steel sheet manufactured at Step S501 is cut so that the shape of the sheet surface of the cut steel sheet becomes the planar shape of the blocks 110a to 110e (the shape of the x-y plane illustrated in FIG. 1). A well-known method may be employed as the method of cutting the steel sheet. For example, the cutting of the steel sheet may be performed by punching. Further, the cutting of the steel sheet may also be performed by laser beam machining. Further, the number of steel sheets to be cut at one time at the cutting step is not limited. The steel sheets may be cut one by one. The plural steel sheets may be cut at one time.

Next, at Step S503, a crystal grain measuring step is performed. At the crystal grain measuring step, calculating (measuring) the number of crystal grains per unit length on the steel sheet facing end surface n/L and checking whether or not to satisfy (3) Expression are performed. In this embodiment, first, the number of crystal grains on the steel sheet facing end surface n of the steel sheet cut at Step S502 and the length L of the steel sheet facing end surface are measured. Then, the number of crystal grains per unit length on the steel sheet facing end surface n/L is calculated. Then, whether or not the number of crystal grains per unit length on the steel sheet facing end surface n/L satisfies (3) Expression is determined. For example, when calculating the number of crystal grains per unit length on the steel sheet facing end surface n/L at each of the block facing end surfaces 111a to 111p, the determination whether or not to satisfy (3) Expression is performed at each of the block facing end surfaces 111a to 111p. In this case, the representative value (for example, the arithmetic mean value) of the number of crystal grains n on the steel sheet facing end surface that forms part of one block facing end surface and the representative value (for example, the arithmetic mean value) of the length L of the steel sheet facing end surface that forms part of the one block facing end surface are used as n and L in (3) Expression respectively.

At least one of the following may be performed by a computer: calculating the number of crystal grains per unit length on the steel sheet facing end surface n/L; and determining whether or not the number of crystal grains per unit length on the steel sheet facing end surface n/L satisfies (3) Expression. In this case, for example, information including the number of crystal grains on the steel sheet facing end surface n of the steel sheet and the length L of the steel sheet facing end surface may be input to the computer. Further, at least one of the following may be performed manually: calculating the number of crystal grains per unit length on the steel sheet facing end surface n/L; and determining whether or not the number of crystal grains per unit length on the steel sheet facing end surface n/L satisfies (3) Expression.

When the number of crystal grains per unit length on the steel sheet facing end surface n/L does not satisfy (3) Expression, for example, Step S501 is performed again, Incidentally, in this case, only the steel sheet that does not satisfy (3) Expression is manufactured at Step S501.

When the number of crystal grains per unit length on the steel sheet facing end surface n/L satisfies (3) Expression at all of the block facing end surfaces 111a to 111p, a first roughness measuring step is performed at Step S504. At the first roughness measuring step, the in-plane-direction surface roughness Ra(S) of the steel sheet cut at Step S502 is calculated (measured). In this embodiment, first, the roughness curve of the steel sheet cut Step S502 is measured at the in-plane-direction measurement positions (positions of the virtual straight lines 301a to 301c). Then, the in-plane-direction surface roughness Ra(S) is calculated based on the roughness curves at the in-plane-direction measurement positions. The calculation of the in-plane-direction surface roughness Ra(S) is performed for all of the steel sheets that form the blocks 110a to 110e, for example. The calculation of the in-plane-direction surface roughness Ra(S) may be performed by a computer. Further, the calculation of the in-plane-direction surface roughness Ra(S) may also be performed manually.

Next, at Step S505, a second roughness measuring step is performed. At the second roughness measuring step, the laminating-direction surface roughness Ra(D) of the block facing end surface of the block including the steel sheet being a measurement target for the in-plane-direction surface roughness Ra(S) is calculated (measured). In this embodiment, first, all of the steel sheets forming one certain block are taken out of the steel sheets cut at Step S502. Then, the roughness curves of the steel sheets forming the block are measured at the laminating-direction measurement positions (positions on the virtual straight lines 201a to 201p). Then, the laminating-direction surface roughness Ra(D) is calculated based on the roughness curves at the laminating-direction measurement positions. The calculation of the laminating-direction surface roughness Ra(D) is performed, for example, at all of the block facing end surfaces 111a to 111p in all of the blocks 110a to 110e that form the laminated core 100. The calculation of the laminating-direction surface roughness Ra(D) may be performed by a computer. Further, the calculation of the laminating-direction surface roughness Ra(D) may also be performed manually.

Next, at Step S506, a roughness adjusting step is performed. At the roughness adjusting step, determining whether or not (1) Expression (and further (2) Expression preferably) are satisfied at each of a pair of block facing end surfaces, and adjusting the surface roughness of the block facing end surface that does not satisfy (1) Expression (and further does not satisfy (2) Expression preferably) are performed.

In this embodiment, first, while using the in-plane-direction surface roughnesses Ra(S) and the laminating-direction surface roughnesses Ra(D) calculated (measured) at a pair of block facing end surfaces (for example, the pair of block facing end surfaces 111a and 111i), at each of the pair of block facing end surfaces, whether or not to satisfy (1) Expression (and further (2) Expression preferably) is determined. This determination is performed, for example, at all of the block facing end surfaces 111a to 111p of the blocks 110a to 110e. Further, this determination may also be performed by a computer. Further, this determination may also be performed manually.

Then, the roughness of the steel sheet facing end surface that does not satisfy (1) Expression (and further does not satisfy (2) Expression preferably) is adjusted. The adjustment of the roughness of the end surface of the steel sheet is performed, for example, at, out of all of the block facing end surfaces 111a to 111p of the blocks 110a to 110e, all of the block facing end surfaces that do not satisfy (1) Expression (and further do not satisfy (2) Expression preferably).

Then, at the block facing end surface whose roughness has been adjusted as above, whether or not to satisfy (1) Expression (and further (2) Expression preferably) is determined again. The determination whether or not to satisfy (1) Expression (and further (2) Expression preferably) and the adjustment of the roughness of the end surface of the steel sheet are performed repeatedly until there are no more block facing end surfaces that do not satisfy (1) Expression (and further do not satisfy (2) Expression preferably).

As above, this embodiment is configured to satisfy 1<Ra(D)/Ra(S)≤12 at each of at least one pair of block facing end surfaces (for example, the pair of block facing end surface 111a and 111i). Therefore, it is possible to provide a laminated core that is capable of inhibiting vibration without using a material different from the steel sheet. Further, 1<Ra(D)/Ra(S)≤12 is changed to 6≤Ra(D)/Ra(S)≤8, thereby making it possible to more reliably improve the effect of inhibiting noise of the laminated core 100.

Further, in this embodiment, at at least one of at least one pair of block facing end surfaces (for example, the block facing end surfaces 111a and 111i), the number of crystal grains per unit length on the steel sheet facing end surface n/L is set to 0.5 or less. Therefore, it is possible to further inhibit noise of the laminated core.

Incidentally, the embodiment of the present invention explained above merely illustrates concrete examples of implementing the present invention, and the technical scope of the present invention is not to be construed in a restrictive manner by the embodiment. That is, the present invention may be implemented in various forms without departing from the technical spirit or main features thereof.

### EXAMPLE

There is explained an example of the present invention below. Incidentally, the present invention is not limited to this example. That is, the various conditions explained in this example are example conditions employed to confirm the feasibility, effects and the like of the present invention. Therefore, the present invention is not limited to the example conditions explained in this embodiment. Further, the present invention may employ various conditions as long as they do not deviate from the gist of the present invention and achieve the object of the present invention.

### (Grain-Oriented Electrical Steel Sheet)

Single grain-oriented electrical steel sheets were manufactured using slabs of Material types A to E having chemical compositions illustrated in Table 1 respectively. The unit of values illustrated in Table 1 is mass %. Further, the balance of each slab (chemical component other than the chemical components illustrated in Table 1) is Fe.

TABLE 1

| MATERIAL | SLAB | | | | | | | | | |
|---|---|---|---|---|---|---|---|---|---|---|
| TYPE | C | Si | Mn | S | Al | N | Cu | Bi | B | Nb |
| A | 0.070 | 3.26 | 0.07 | 0.025 | 0.026 | 0.008 | 0.07 | — | — | — |
| B | 0.070 | 3.26 | 0.07 | 0.025 | 0.026 | 0.008 | 0.07 | — | — | 0.007 |
| C | 0.070 | 3.26 | 0.07 | 0.025 | 0.025 | 0.008 | 0.07 | 0.002 | — | — |
| D | 0.060 | 3.45 | 0.10 | 0.006 | 0.027 | 0.008 | 0.20 | — | — | 0.005 |
| E | 0.060 | 3.45 | 0.10 | 0.006 | 0.027 | 0.008 | 0.20 | — | 0.002 | — |

Grain-oriented electrical steel sheets were manufactured using the slabs of Material types A to E according to the manufacturing steps and manufacturing conditions illustrated in Table 2.

TABLE 2

| | | | | | | | COLD ROLLING | |
|---|---|---|---|---|---|---|---|---|
| | HOT ROLLING | | | | HOT-ROLLED SHEET | | | COLD- |
| | HEATING | FINISHING | COILING | SHEET | ANNEALING | | SHEET | ROLLING |
| MATERIAL | TEMPERATURE | TEMPERATURE | TEMPERATURE | THICKNESS | TEMPERATURE | TIME | THICKNESS | RATIO |
| TYPE | °C | °C | °C | mm | °C | s | mm | % |
| A | 1150 | 880 | 650 | 2.3 | 1150 | 180 | 0.23 | 90.0 |
| B | 1150 | 880 | 650 | 2.3 | 1150 | 180 | 0.23 | 90.0 |
| C | 1150 | 880 | 650 | 2.3 | 1150 | 180 | 0.23 | 90.0 |
| D | 1150 | 880 | 650 | 2.3 | 1150 | 180 | 0.23 | 90.0 |
| E | 1150 | 880 | 650 | 2.3 | 1150 | 180 | 0.23 | 90.0 |

| | DECARBURIZING ANNEALING | | | NITRIDING TREATMENT | | | |
|---|---|---|---|---|---|---|---|
| | | | SHEET | SHEET | AMOUNT | | |
| | | | PASSING | PASSING | OF | BATCH ANNEALING | |
| MATERIAL | TEMPERATURE | TIME | TENSION | TENSION | NITRIDING | TEMPERATURE | TIME |
| TYPE | °C | s | N/mm² | N/mm² | ppm | °C | h r |
| A | 850 | 180 | 4.5~5.5 | 4.5~5.5 | 80 | 950 | 20 |
| B | 850 | 180 | 4.5~5.5 | 4.5~5.5 | 130 | 950 | 20 |
| C | 850 | 180 | 4.5~5.5 | 4.5~5.5 | 250 | 1100 | 20 |
| D | 850 | 180 | 4.5~5.5 | 4.5~5.5 | 250 | 1100 | 50 |
| E | 850 | 180 | 4.5~5.5 | 4.5~5.5 | 250 | 1100 | 200 |

As illustrated in Table 2, a hot rolling step, a hot-rolled sheet annealing step, a cold rolling step, a decarburizing annealing step, a nitriding treatment (nitriding annealing) step, and a batch annealing step were performed in this order under the manufacturing conditions illustrated in Table 2.

In this example, a nitriding treatment (nitriding was performed on a cold-rolled steel sheet after decarburizing annealing in a mixed atmosphere of hydrogen-nitrogen-ammonia. The amount of nitriding was adjusted by adjusting the flow rate of ammonia through ammonia nitriding. Further, an annealing separating agent containing, as its main component, magnesia or alumina was applied to the cold-rolled steel sheet, and then batch annealing was performed thereon. Several types of annealing separating agents with different mixing ratios of components containing the main component were used as the annealing separating agent. Further, an annealing temperature during batch annealing and a holding time at the annealing temperature were adjusted. In this example, the crystal grain diameter of the steel sheet after batch annealing was controlled by the amount of nitriding in the nitriding treatment and the annealing temperature and the holding time during the batch annealing.

An insulating coating film coating solution was applied onto a primary coating film formed on the surface of the steel sheet after batch annealing. As the insulating coating film coating solution, a solution containing, as its main component, phosphate and colloidal silica and containing chromium was used. An insulating coating film was formed by heat-treating the steel sheet with the insulating coating film coating solution applied thereto. In this example, the single grain-oriented electrical steel sheets were manufactured from the slabs of Material types A to E in the manner described above respectively. In the following explanation, the single grain-oriented electrical steel sheets manufactured from the slabs of Material types A to E are referred to as steel sheets of Material types A to E as necessary

### (Laminated Core)

A laminated core 100 having the shape illustrated in FIG. 1 was manufactured using the steel sheet of Material type A as a material. The present inventors found out that there is a direct proportional relationship between Ra(D)/Ra(S) illustrated in (1) Expression and a clearance. In this example, when cutting the steel sheet of Material type A to obtain the planar shapes of the blocks 110a to 110e, the clearance between upper and lower blades of a shearing machine was controlled based on these findings, to thereby adjust the roughness of the end surface of the steel sheet of Material type A. Each of the blocks 110a to 110e was manufactured by laminating the steel sheets of Material type A having the planar shapes of the blocks 110a to 110e. At this time, plural sets of the blocks 110a to 110e having the block facing end surfaces 111a to 111p whose roughnesses are mutually different were manufactured as the set of the blocks 110a to 110e. Regarding the steel sheets of Material types B to E as well, plural sets of the blocks 110a to 110e were manufactured in the same manner.

In the following explanation, the blocks manufactured from the steel sheets of Material types A to E are referred to as blocks of Material types A to E as necessary. Further, in the following explanation, the block 110a, the block 110b, the block 110c, the block 110d, and the block 110e are referred to as an upper block 110a, a lower block 110b, a left block 110c, a center block 110d, and a right block 110e as necessary.

The blocks 110a to 110e manufactured from the steel sheets of the same material type were combined to manufacture the laminated core 100. In the following explanation, the laminated core 100 manufactured in this manner is referred to as a laminated core 100 of Material types A to E as necessary. Further, the left block 110c, the center block 110d, the right block 110e, the upper block 110a, and the lower block 110b were manufactured from the steel sheets of different types as the block, and the blocks 110a to 110e were combined to manufacture a laminated core 100. Specifically, a laminated core 100 of Material types A and B, a laminated core 100 of Material types A and D, a laminated core 100 of Material types B and C, and a laminated core 100 of Material types B and E were manufactured. The laminated core 100 of Material types A and B is a laminated core in which the left block 110c, the center block 110d, and the right block 110e are made of the steel sheet of Material type A and the upper block 110a and the lower block 110b are made of the steel sheet of Material type B. The laminated core 100 of Material types A and D is a laminated core in which the left block 110c, the center block 110d, and the right block 110e are made of the steel sheet of Material type A and the upper block 110a and the lower block 110b are made of the steel sheet of Material type D. The laminated core 100 of Material types B and C is a laminated core in which the left block 110c, the center block 110d, and the right block 110e are made of the steel sheet of Material type B and the upper block 110a and the lower block 110b are made of the steel sheet of Material type C. The laminated core 100 of Material types B and E is a laminated core in which the left block 110c, the center block 110d, and the right block 110e are made of the steel sheet of Material type E and the upper block 110a and the lower block 110b are made of the steel sheet of Material type B.

The width (length in the y-axis direction), the height (length in the x-axis direction), and the thickness (length in the z-axis direction) of the laminated core 100 were 750 mm, 750 mm, and about 41 mm respectively. Further, the widths (length in the x-axis direction) of the upper block 110a and the lower block 110b and the widths (length in the y-axis direction) of the left block 110c, the center block 110d, and the right block 110e were 150 mm.

### (Evaluation Method)

The lengths L (L1 to L15) of the steel sheet facing end surfaces of the steel sheets of Material types A to E having the planar shapes of the blocks 110a to 110e were measured with a vernier caliper. Further, the steel sheet facing end surfaces (shear surfaces) of these steel sheets were corroded with a 5% nital solution for 100 to 300 seconds. Thereafter, these steel sheet facing end surfaces were observed with an industrial microscope BX53M manufactured by OLYMPUS CORPORATION, to thereby count the number of crystal grain boundaries present in the steel sheet facing end surfaces. Then, the number of crystal grains on the steel sheet facing end surface n was calculated by adding 1 to the counted number. The number of crystal grains per unit length on the steel sheet facing end surface n/L was calculated from the length L of the steel sheet facing end surface and the number of crystal grains on the steel sheet facing end surface n obtained from the same steel sheet. The number of crystal grains per unit length on the steel sheet facing end surface n/L of each of all of the steel sheets that form the blocks 110a to 110e was calculated. Then, the arithmetic mean value of the numbers of crystal grains per unit length on the steel sheet facing end surface n/L was calculated at each of the block facing end surfaces 111a to 111p. The arithmetic mean value of the number of crystal grains per unit length on the steel sheet facing end surface n/L calculated at one block facing end surface was set as the number of crystal grains per unit length on the steel sheet facing end surface n/L at the block facing end surface.

Further, for each of the laminated cores 100 manufactured as described above (the laminated core 100 of Material types A to E, the laminated core 100 of Material types A and B, the laminated core 100 of Material types A and D, the laminated core 100 of Material types B and C, and the laminated core 100 of Material types B and E), the laminating-direction surface roughness Ra(D) and the in-plane-direction surface roughness Ra(S) were calculated in accordance with JIS B 0601:2013.

Regarding each of the block facing end surfaces 111a to 111p of each of the laminated cores 100, the plural steel sheets forming the block facing end surface were extracted one by one, and the laminating-direction surface roughness Ra(D) of the extracted steel sheet was measured at the laminating-direction measurement positions (positions on the virtual straight lines 201a to 201p) using a one-shot 3D shape measuring machine (model name: VR-6000) manufactured by KEYENCE CORPORATION. Then, the arithmetic mean value of the laminating-direction surface roughnesses Ra(D) of the block facing end surface calculated from the plural steel sheets forming the same block facing end surface was calculated as the laminating-direction surface roughness Ra(D) of the block facing end surface.

Further, regarding each of the block facing end surfaces 111a to 111p of each of the laminated cores 100, the plural steel sheets forming the block facing end surface were extracted one by one, and the in-plane-direction surface roughness Ra(S) of the extracted steel sheet was measured at the in-plane-direction measurement positions (positions on the virtual straight lines 301a to 301e) using a one-shot 3D shape measuring machine (model name: VR-6000) manufactured by KEYENCE CORPORATION. Then, the arithmetic mean value of the in-plane-direction surface roughnesses Ra(S) of the block facing end surface calculated from the plural steel sheets forming the same block facing end surface was calculated as the in-plane-direction surface roughness Ra(S) of the block facing end surface.

Then, Ra(D)/Ra(S) of the block facing end surface was calculated from the laminating-direction surface roughness Ra(D) and the in-plane-direction surface roughness Ra(S) at the same block facing end surface. Such calculation of Ra(D)/Ra(S) was performed at all of the block facing end surfaces 111a to 111p of all of the laminated cores 100 manufactured as described above.

The noise of each of the laminated cores 100 (the laminated core 100 of Material types A to E, the laminated core 100 of Material types A and B, the laminated core 100 of Material types A and D, the laminated core 100 of Material types B and C, and the laminated core 100 of Material types B and E) was measured. Specifically, in an anechoic chamber with a background noise of 16 dBA, a noise meter was placed at a distance of 0.3 m from the surface of the laminated core 100. The noise meter was used to measure the noise of the laminated core 100 using A-weighting as frequency weighting. At that time, the laminated core 100 was excited under the excitation conditions of an excitation frequency=50 Hz and a magnetic flux density inside the laminated core 100=1.7 T. Table 3 and Table 4 illustrate the values of n/L, Ra(D)/Ra(S), and noise of each of the laminated cores 100 obtained in this manner. In Table 1, 111a to 111p indicate the block facing end surfaces 111a to 111p illustrated in FIG. 1, FIG. 2A to FIG. 2E, FIG. 3A to FIG. 3E, and FIG. 4A to FIG. 4E.

TABLE 3

| | MATERIAL | n/L | Ra(D)/Ra(S) | | | | | | | |
|---|---|---|---|---|---|---|---|---|---|---|
| NUMBER | TYPE | (grains/mm) | 111i | 111a | 111j | 111f | 111m | 111c | 111n | 111d |
| 1 | A | 0.83 | 1 | 1 | 1 | 1 | 1 | 1 | 1 | 1 |
| 2 | A | 0.83 | 2 | 2 | 1 | 1 | 1 | 1 | 1 | 1 |
| 3 | A | 0.83 | 1 | 1 | 2 | 2 | 2 | 2 | 1 | 1 |
| 4 | A | 0.83 | 2 | 2 | 2 | 2 | 2 | 2 | 2 | 2 |
| 5 | A | 0.83 | 12 | 12 | 1 | 1 | 1 | 1 | 1 | 1 |
| 6 | A | 0.83 | 12 | 12 | 12 | 12 | 12 | 12 | 12 | 12 |
| 7 | A | 0.83 | 1 | 1 | 1 | 1 | 1 | 1 | 1 | 1 |
| 8 | A | 0.83 | 6 | 6 | 1 | 1 | 6 | 6 | 6 | 6 |
| 9 | A | 0.83 | 8 | 8 | 1 | 1 | 8 | 8 | 8 | 8 |
| 10 | A | 0.83 | 3 | 3 | 1 | 1 | 3 | 3 | 3 | 3 |
| 11 | A | 0.83 | 6 | 6 | 6 | 6 | 6 | 6 | 6 | 6 |
| 12 | A | 0.83 | 8 | 8 | 8 | 8 | 8 | 8 | 8 | 8 |
| 13 | A | 0.83 | 12 | 12 | 12 | 12 | 12 | 12 | 12 | 12 |
| 14 | A | 0.83 | 13 | 13 | 13 | 13 | 13 | 13 | 13 | 13 |
| 15 | A | 0.83 | 17 | 17 | 17 | 17 | 17 | 17 | 17 | 17 |
| 16 | A | 0.83 | 1 | 1 | 1 | 1 | 1 | 1 | 1 | 1 |
| 17 | A | 0.83 | 1 | 1 | 1 | 1 | 7 | 7 | 1 | 1 |
| 18 | A | 0.83 | 5 | 5 | 1 | 1 | 1 | 1 | 5 | 5 |
| 19 | A | 0.83 | 6 | 6 | 1 | 1 | 1 | 1 | 6 | 6 |
| 20 | A | 0.83 | 1 | 1 | 8 | 7 | 6 | 6 | 1 | 1 |

| | Ra(D)/Ra(S) | | | | | | | | NOISE |
|---|---|---|---|---|---|---|---|---|---|
| NUMBER | 111p | 111h | 111o | 111g | 111k | 111e | 111l | 111b | (dBA) |
| 1 | 1 | 1 | 1 | 1 | 1 | 1 | 1 | 1 | 58 |
| 2 | 1 | 1 | 1 | 1 | 1 | 1 | 1 | 1 | 54 |
| 3 | 1 | 1 | 1 | 1 | 1 | 1 | 1 | 1 | 51 |
| 4 | 2 | 2 | 2 | 2 | 2 | 2 | 2 | 2 | 48 |
| 5 | 1 | 1 | 1 | 1 | 1 | 1 | 1 | 1 | 53 |
| 6 | 1 | 1 | 1 | 1 | 1 | 1 | 1 | 1 | 48 |
| 7 | 12 | 12 | 12 | 12 | 12 | 12 | 12 | 12 | 51 |
| 8 | 6 | 6 | 6 | 6 | 1 | 1 | 1 | 1 | 44 |
| 9 | 8 | 8 | 8 | 8 | 1 | 1 | 1 | 1 | 43 |
| 10 | 3 | 3 | 3 | 3 | 1 | 1 | 1 | 1 | 47 |
| 11 | 6 | 6 | 6 | 6 | 6 | 6 | 6 | 6 | 43 |
| 12 | 8 | 8 | 8 | 8 | 8 | 8 | 8 | 8 | 42 |
| 13 | 12 | 12 | 12 | 12 | 12 | 12 | 12 | 12 | 48 |
| 14 | 13 | 13 | 13 | 13 | 13 | 13 | 13 | 13 | 58 |
| 15 | 17 | 17 | 17 | 17 | 17 | 17 | 17 | 17 | 57 |
| 16 | 4 | 4 | 4 | 4 | 1 | 1 | 1 | 1 | 51 |
| 17 | 1 | 1 | 7 | 7 | 1 | 1 | 7 | 7 | 49 |
| 18 | 7 | 7 | 2 | 2 | 1 | 1 | 8 | 8 | 49 |
| 19 | 1 | 1 | 1 | 1 | 6 | 6 | 1 | 1 | 49 |
| 20 | 8 | 8 | 1 | 1 | 1 | 1 | 4 | 12 | 49 |

TABLE 4

| | MATERIAL | n/L | Ra(D)/Ra(S) | | | | | | | |
|---|---|---|---|---|---|---|---|---|---|---|
| NUMBER | TYPE | (grains/mm) | 111i | 111a | 111j | 111f | 111m | 111c | 111n | 111d |
| 21 | B | 0.50 | 1 | 1 | 1 | 1 | 1 | 1 | 1 | 1 |
| 22 | C | 0.05 | 1 | 1 | 1 | 1 | 1 | 1 | 1 | 1 |
| 23 | D | 0.02 | 1 | 1 | 1 | 1 | 1 | 1 | 1 | 1 |
| 24 | E | 0.005 | 1 | 1 | 1 | 1 | 1 | 1 | 1 | 1 |
| 25 | B | 0.50 | 2 | 2 | 2 | 2 | 2 | 2 | 2 | 2 |
| 26 | C | 0.05 | 2 | 2 | 2 | 2 | 2 | 2 | 2 | 2 |
| 27 | D | 0.02 | 2 | 2 | 2 | 2 | 2 | 2 | 2 | 2 |
| 28 | E | 0.01 | 2 | 2 | 2 | 2 | 2 | 2 | 2 | 2 |
| 29 | B | 0.50 | 8 | 8 | 8 | 8 | 8 | 8 | 8 | 8 |
| 30 | C | 0.05 | 8 | 8 | 8 | 8 | 8 | 8 | 8 | 8 |
| 31 | D | 0.02 | 8 | 8 | 8 | 8 | 8 | 8 | 8 | 8 |
| 32 | E | 0.01 | 8 | 8 | 8 | 8 | 8 | 8 | 8 | 8 |
| 33 | B | 0.50 | 12 | 12 | 12 | 12 | 12 | 12 | 12 | 12 |
| 34 | C | 0.05 | 12 | 12 | 12 | 12 | 12 | 12 | 12 | 12 |
| 35 | D | 0.02 | 12 | 12 | 12 | 12 | 12 | 12 | 12 | 12 |
| 36 | E | 0.01 | 12 | 12 | 12 | 12 | 12 | 12 | 12 | 12 |
| 37 | B | 0.50 | 12 | 12 | 1 | 1 | 1 | 1 | 1 | 1 |
| 38 | C | 0.05 | 12 | 12 | 1 | 1 | 1 | 1 | 1 | 1 |
| 39 | D | 0.02 | 12 | 12 | 1 | 1 | 1 | 1 | 1 | 1 |
| 40 | E | 0.01 | 12 | 12 | 1 | 1 | 1 | 1 | 1 | 1 |
| 41 | B | 0.50 | 1 | 1 | 1 | 1 | 1 | 1 | 1 | 2 |
| 42 | C | 0.05 | 1 | 1 | 1 | 1 | 1 | 1 | 1 | 2 |
| 43 | D | 0.02 | 1 | 1 | 1 | 1 | 1 | 1 | 1 | 2 |
| 44 | E | 0.01 | 1 | 1 | 1 | 1 | 1 | 1 | 1 | 2 |
| 45 | A, B | 0.83, 0.50 | 2 | 2 | 1 | 1 | 1 | 1 | 1 | 1 |
| 46 | A, D | 0.83, 0.02 | 2 | 2 | 1 | 1 | 1 | 1 | 1 | 1 |
| 47 | B, C | 0.50, 0.05 | 2 | 2 | 1 | 1 | 1 | 1 | 1 | 1 |
| 48 | B, E | 0.50, 0.01 | 2 | 2 | 1 | 1 | 1 | 1 | 1 | 1 |

| | Ra(D)/Ra(S) | | | | | | | | NOISE |
|---|---|---|---|---|---|---|---|---|---|
| NUMBER | 111p | 111h | 111o | 111g | 111k | 111e | 111l | 111b | (dBA) |
| 21 | 1 | 1 | 1 | 1 | 1 | 1 | 1 | 1 | 55 |
| 22 | 1 | 1 | 1 | 1 | 1 | 1 | 1 | 1 | 55 |
| 23 | 1 | 1 | 1 | 1 | 1 | 1 | 1 | 1 | 55 |
| 24 | 1 | 1 | 1 | 1 | 1 | 1 | 1 | 1 | 55 |
| 25 | 2 | 2 | 2 | 2 | 2 | 2 | 2 | 2 | 44 |
| 26 | 2 | 2 | 2 | 2 | 2 | 2 | 2 | 2 | 41 |
| 27 | 2 | 2 | 2 | 2 | 2 | 2 | 2 | 2 | 39 |
| 28 | 2 | 2 | 2 | 2 | 2 | 2 | 2 | 2 | 33 |
| 29 | 8 | 8 | 8 | 8 | 8 | 8 | 8 | 8 | 39 |
| 30 | 8 | 8 | 8 | 8 | 8 | 8 | 8 | 8 | 36 |
| 31 | 8 | 8 | 8 | 8 | 8 | 8 | 8 | 8 | 29 |
| 32 | 8 | 8 | 8 | 8 | 8 | 8 | 8 | 8 | 24 |
| 33 | 12 | 12 | 12 | 12 | 12 | 12 | 12 | 12 | 45 |
| 34 | 12 | 12 | 12 | 12 | 12 | 12 | 12 | 12 | 41 |
| 35 | 12 | 12 | 12 | 12 | 12 | 12 | 12 | 12 | 40 |
| 36 | 12 | 12 | 12 | 12 | 12 | 12 | 12 | 12 | 32 |
| 37 | 1 | 1 | 1 | 1 | 1 | 1 | 1 | 1 | 50 |
| 38 | 1 | 1 | 1 | 1 | 1 | 1 | 1 | 1 | 46 |
| 39 | 1 | 1 | 1 | 1 | 1 | 1 | 1 | 1 | 43 |
| 40 | 1 | 1 | 1 | 1 | 1 | 1 | 1 | 1 | 41 |
| 41 | 1 | 1 | 2 | 1 | 1 | 1 | 1 | 1 | 50 |
| 42 | 1 | 1 | 2 | 1 | 1 | 1 | 1 | 1 | 46 |
| 43 | 1 | 1 | 2 | 1 | 1 | 1 | 1 | 1 | 43 |
| 44 | 1 | 1 | 2 | 1 | 1 | 1 | 1 | 1 | 41 |
| 45 | 1 | 1 | 1 | 1 | 1 | 1 | 1 | 1 | 51 |
| 46 | 1 | 1 | 1 | 1 | 1 | 1 | 1 | 1 | 49 |
| 47 | 1 | 1 | 1 | 1 | 1 | 1 | 1 | 1 | 46 |
| 48 | 1 | 1 | 1 | 1 | 1 | 1 | 1 | 1 | 44 |

As illustrated in Table 3 and Table 4, in the laminated cores 100 of the same material type, when the number of pairs of block facing end surfaces 111a and 111i, 111b and 111l, 111c and 111m, 111d and 111n, 111e and 111k, 111f and 111j, 111g and 111o, and 111h and 111p satisfying 1<Ra(D)/Ra(S)≤12 was 1 or more, the noise reduced more compared to the case where the number was 0 (zero). That is, regarding Material type A, the noise was lower in Numbers 2 to 13 and 16 to 20 compared to Numbers 1 and 14 to 15. Regarding Material type B, the noise was lower in Numbers 25, 29, 33, 37, and 41 compared to Number 21. Regarding Material type C, the noise was lower in Numbers 26, 30, 34, 38, and 42 compared to Number 22. Regarding Material type D, the noise was lower in Numbers 27, 31, 35, 39, and 43 compared to Number 23. Regarding Material type E, the noise was lower in Numbers 28, 32, 36, 40, and 44 compared to Number 24.

Further, in the laminated cores 100 of the same material type, when the number of pairs of block facing end surfaces satisfying 1<Ra(D)/Ra(S)≤12 was equal to or more than ½ times the total number of pairs of block facing end surfaces (8 in this embodiment (16 in the number in the column of “Ra(D)/Ra(S)” in Tables 3 and 4)), the noise reduction effect was significant. That is, regarding Material type A, the noise was lower in Numbers 4, 6, 8 to 13, 18, and 19 to 20 compared to Numbers 2, 3, 5, 7, 16, 17, and 19. Regarding Material type B, the noise was lower in Numbers 25, 29, and 33 compared to Numbers 37 and 41. Regarding Material type C, the noise was lower in Numbers 26, 30, and 34 compared to Numbers 38 and 42. Regarding Material type D, the noise was lower in Numbers 27, 31, and 35 compared to Numbers 39 and 43. Regarding Material type E, the noise was lower in Numbers 28, 32, and 36 compared to Numbers 40 and 44.

Further, in the laminated cores 100 of the same type, when there was a place of a pair of block facing end surfaces satisfying 6≤Ra(D)/Ra(S)≤8, the noise further reduced, and when the number of such places was equal to or more than ½ times the total number of pairs of block facing end surfaces (8 in this embodiment (16 in the number in the column of “Ra(D)/Ra(S)” in Tables 3 and 4)), the noise reduction effect was significant. That is, regarding Material type A, the noise was lower in Numbers 8, 9, 11, 12, 19, and 20 compared to Numbers 2 to 7, 10, 13, and 16 to 18, and the noise was lower in Numbers 8, 9, 11, and 12 compared to Numbers 19 and 20. Regarding Material type B, the noise was lower in Number 29 compared to Numbers 25, 33, 37, and 41. Regarding Material type C, the noise was lower in Number 30 compared to Numbers 26, 34, 38, and 42. Regarding Material type D, the noise was lower in Number 31 compared to Numbers 27, 35, 39, and 43. Regarding Material type E, the noise was lower in Number 32 compared to Numbers 28, 36, 40, and 44.

Further, Material types B to E with the number of crystal grains per unit length on the steel sheet facing end surface n/L being 0.5 or less achieved a reduction in the noise compared to Material type A with the number of crystal grains per unit length on the steel sheet facing end surface n/L being greater than 0.5, as long as the condition of Ra(D)/Ra(S) was the same. That is, the noise was lower in Numbers 25 to 28 (Material types B to B) compared to Number 4 (Material type A). Further, the noise was lower in Numbers 29 to 32 (Material types B to E) compared to Number 12 (Material type A). Further, the noise was lower in Numbers 33 to 36 (Material types B to E) compared to Number 13 (Material type A).

Further, a combination of different material types was selected, thereby making it possible to increase the number of block facing end surfaces that satisfy 1<Ra(D)/Ra(S)≤12, and increase the number of block facing end surfaces with the number of crystal grains per unit length on the steel sheet facing end surface n/L being 0.5 or less, resulting in that it was possible to obtain the effect of reducing noise. That is, the noise was lower in Numbers 45 and 46 (Material types A and B) compared to Number 2 (Material type A), The noise was lower in Number 47 (Numbers B and C) compared to Numbers 21 (Material type B) and 22 (Material type C). The noise was lower in Number 48 (Numbers B and E) compared to Numbers 21 (Material type B) and 26 (Material type E).

### INDUSTRIAL APPLICABILITY

The present invention can be used in devices including a core, for example.

1.-4. (canceled)

5. A laminated core, comprising:
a plurality of blocks, each of the blocks including a plurality of laminated steel sheets, wherein
the plural blocks include block facing end surfaces,
the block facing end surface is, of end surfaces of the block, an end surface that is located at a position facing the another block each other,
at each of at least one pair of the block facing end surfaces, (A) Expression below is satisfied, and
the pair of block facing end surfaces is the two block facing end surfaces that are arranged at positions facing each other,
1<Ra(D)/Ra(S)≤12 (A)
wherein, Ra(D) is surface roughness Ra (μm) of the block facing end surface in a laminating direction of the steel sheet, and Ra(S) is surface roughness Ra (μm) of a sheet surface of the steel sheet having an end surface that forms part of the block facing end surface in a direction of a main magnetic flux flowing through the steel sheet or in a rolling direction of the steel sheet.

6. The laminated core according to claim 5, wherein
at each of the at least one pair of block facing end surfaces, (B) Expression below is satisfied,
6≤Ra(D)/Ra(S)≤8 (B).

7. The laminated core according to claim 5, wherein
for at least one of the block facing end surfaces of the at least one pair of block facing end surfaces, (C) Expression below is satisfied,
n/L≤0.5 (C)
wherein, n is the number of crystal grains (grains) including the end surface as a boundary out of crystal grains present in the steel sheet that forms part of the block facing end surface, and L is the length (mm) of the end surface.

8. The laminated core according to claim 6, wherein
for at least one of the block facing end surfaces of the at least one pair of block facing end surfaces, (C) Expression below is satisfied,
n/L≤0.5 (C)
wherein, n is the number of crystal grains (grains) including the end surface as a boundary out of crystal grains present in the steel sheet that forms part of the block facing end surface, and L is the length (mm) of the end surface.

9. A manufacturing method of a laminated core, the laminated core including a plurality of blocks, each of the blocks including a plurality of laminated steel sheets, the method comprising:
a cutting step that cuts a steel sheet;
a first roughness measuring step that measures surface roughness Ra(S) (μm) of a sheet surface of a steel sheet cut at the cutting step;
a second roughness measuring step that measures surface roughness Ra(D) (μm) of a block facing end surface of the block including the steel sheet being a measurement target for the surface roughness Ra(S); and
a roughness adjusting step that adjusts surface roughness of the block facing end surface when the ratio Ra(D)/Ra(S) of surface roughness Ra(D) measured by the second roughness measuring step to surface roughness Ra(S) measured by the first roughness measuring step does not satisfy 1<Ra(D)/Ra(S)≤12, wherein
the surface roughness Ra(S) is surface roughness Ra (μm) in a direction of a main magnetic flux flowing through the steel sheet when the laminated core is excited, or surface roughness Ra (μm) in a rolling direction of the steel sheet,
the surface roughness Ra(D) is surface roughness Ra (μm) in a laminating direction of the steel sheet,
the block facing end surface is, of end surfaces of the block, an end surface that is located at a position facing the another block each other in the laminated core,
at the roughness adjusting step, the surface roughness of the block facing end surface is adjusted to satisfy 1<Ra(D)/Ra(S)≤12 at each of at least one pair of the block facing end surfaces, and
the pair of block facing end surfaces is the two block facing end surfaces that are arranged at positions facing each other.
